(19) United States
(12) Patent Application Publication
(10) Pub. No.: US 2022/0148075 A1
(43) Pub. Date: May 12, 2022

(54) SYSTEM AND METHODS FOR DYNAMICALLY AUTOMATING REVERSE AUCTIONS

(71) Applicant: QMO IP Pty Ltd., Sydney (AU)

(72) Inventors: Karl Kazal, Sydney (AU); Abraham Kazal, Sydney (AU); Pawel Kaplanski, Sydney (AU)

(73) Assignee: QMO IP Pty Ltd., Sydney (AU)

(21) Appl. No.: 17/522,510

(22) Filed: Nov. 9, 2021

Related U.S. Application Data
(60) Provisional application No. 63/111,113, filed on Nov. 9, 2020.

(51) Int. Cl. G06Q 30/08; G06Q 10/08

(52) U.S. Cl. CPC G06Q 30/08; G06Q 10/083

(57) ABSTRACT

Provided for is a system for dynamically ranking buyers and sellers in an auction comprising granting access to one or more buyers on the computer system; assigning a seller permission; assigning a buyer permission; providing, to the seller and the buyer, a platform; receiving, via the platform, one or more desired items; receiving a plurality of parameter fields; populating each of the plurality of parameter fields with one or more parameter values; receiving the plurality of parameter fields and one or more parameter values from at least one of the buyer and seller; standardizing the one or more parameter values and the plurality of parameter fields into one or more Stock Standard Form (SSF) details; initiating an Inventory Standardization Service (ISS); initiating an optimization; and calculating a final price for the one or more desired items.

### CLAIM OF PRIORITY

This application claims the benefit of U.S. Provisional Patent Application No. 63/111,113, filed Nov. 9, 2020, which is incorporated by reference herein in its entirety.

### FIELD OF THE INVENTION

The invention of the present disclosure relates to systems and methods of auctioning. More specifically, the invention relates to automation of reverse auctioning.

### INTRODUCTION

Improvements in computer technology, logistics, and precision delivery have resulted in a multitude of options for purchasing and fulfilling orders.

As technology progresses and communications improve, sales channels are improved, and in some instances, new ones are created. Purchasers of goods and services now have to contend with an oversupply of product, and a glut of options to sift through based on quality, delivery period, stock keeping unit (“SKU”), quantity, seller reputation, and other similar or related parameters (“purchase parameters”).

For commercial or industrial purchasers especially, in some instances, required purchase parameters may be unavailable from a single merchant. For example, one merchant may be capable of supplying the correct quantity and SKU, but may be incapable of doing so at the desired price, or may only be able to supply a portion of them in the correct time period.

In order to negotiate favorable terms, auction systems are often used. A web-based auction may be utilized, to increase participation. In instances where an entity wishes to open up bidding for the right to provide goods or services, the entity may initiate a reverse auction, such that the price of the goods or services decreases during the auction, resulting in a more compelling bid.

Current systems may address these issues by forcing the purchasers and sellers to manually negotiate or correspond, negating the benefits of an improved automation in technology and fulfillment.

It would be desirable, therefore, to provide systems and methods for reverse auctions. It would be further desirable to provide systems and methods that dynamically account for purchase parameters, while optimizing the matching of purchasers and sellers.

It would be yet further desirable to provide systems and methods for fully automated dynamic reverse auctions, without interim input from either party.

It would be further desirable to provide systems and methods where neither party is in control of the reverse auction, and optimization occurs.

It would be yet further desirable to provide such optimization, in order to remove subjectivity and hesitation by a buyer of a product.

It would be even further desirable to provide a standardized format for inputting variables into a reverse auction, while properly pairing the desired specifications.

In accordance with these desires, systems and methods for automated reverse auctions are hereby provided.

### BRIEF DESCRIPTION OF THE DRAWINGS

FIG. 1 is an illustrative block diagram of a system based on a computer.

FIG. 2 shows an illustration of an apparatus configured to execute embodiments of the invention.

FIG. 3 is a workflow depicting an embodiment of the system.

FIG. 4 is an illustration showing buyer and seller interaction with an Automated Reverse Auction Solver and Inventory Standardization Service.

FIG. 5 illustrates an embodiment of implementation of an optimization process.

### DETAILED DESCRIPTION

The detailed description provided herein, along with accompanying figures, illustrates one or more embodiments, but is not intended to describe all possible embodiments. The detailed description provides exemplary systems and methods of technologies, but is not meant to be limiting, and similar or equivalent technologies, systems, and/or methods may be realized according to other examples as well. The terms “Item” and “product” may be interchangeable as used herein unless expressed otherwise.

Those skilled in the art will realize that storage devices utilized to provide computer-readable and computer-executable instructions and data can be distributed over a network. For example, a remote computer or storage device may store computer-readable and computer-executable instructions in the form of software applications and data. A local computer may access the remote computer or storage device via the network and download part or all of a software application or data and may execute any computer-executable instructions. Alternatively, the local computer may download pieces of the software or data as needed, or distributively process the software by executing some of the instructions at the local computer and some at remote computers and/or devices.

Those skilled in the art will also realize that, by utilizing conventional techniques, all or portions of the software's computer-executable instructions may be carried out by a dedicated electronic circuit such as a digital signal processor (“DSP”), programmable logic array (“PLA”), discrete circuits, and the like. The term “electronic apparatus” may include computing devices or consumer electronic devices comprising any software, firmware or the like, or electronic devices or circuits comprising no software, firmware or the like.

The term “firmware” as used herein typically includes and refers to executable instructions, code, data, applications, programs, program modules, or the like maintained in an electronic device such as a ROM. The term “software” as used herein typically includes and refers to computer-executable instructions, code, data, applications, programs, program modules, firmware, and the like maintained in or on any form or type of computer-readable media that is configured for storing computer-executable instructions or the like in a manner that may be accessible to a computing device.

The terms “computer-readable medium”, “computer-readable media”, and the like as used herein and in the claims are limited to referring strictly to one or more statutory apparatus, article of manufacture, or the like that is not a signal or carrier wave per se. Thus, computer-readable media, as the term is used herein, is intended to be and must be interpreted as statutory subject matter.

The term “computing device” as used herein and in the claims is limited to referring strictly to one or more statutory apparatus, article of manufacture, or the like that is not a signal or carrier wave per se, such as computing device 101 that encompasses client devices, mobile devices, one or more servers, network services such as an Internet services or corporate network services based on one or more computers, and the like, and/or any combination thereof. Thus, a computing device, as the term is used herein, is also intended to be and must be interpreted as statutory subject matter.

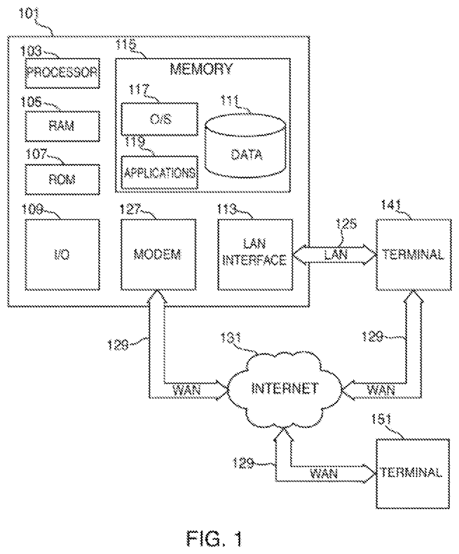

FIG. 1 is an illustrative block diagram of system 100 based on a computer 101. The computer 101 may have a processor 103 for controlling the operation of the device and its associated components, and may include RAM 105, ROM 107, input/output module 109, and a memory 115. The processor 103 will also execute all software running on the computer—e.g., the operating system. Other components commonly used for computers such as EEPROM or Flash memory or any other suitable components may also be part of the computer 101.

The memory 115 may be comprised of any suitable permanent storage technology—e.g., a hard drive. The memory 115 stores software including the operating system 117 any application(s) 119 along with any data 111 needed for the operation of the system 100. Alternatively, some or all of computer executable instructions may be embodied in hardware or firmware (not shown). The computer 101 executes the instructions embodied by the software to perform various functions.

Input/output (“I/O”) module may include connectivity to a microphone, keyboard, touch screen, and/or stylus through which a user of computer 101 may provide input, and may also include one or more speakers for providing audio output and a video display device for providing textual, audiovisual and/or graphical output.

System 100 may be connected to other systems via a LAN interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program(s) 119, which may be used by computer 101, may include computer executable instructions for invoking user functionality related to communication, such as email, Short Message Service (SMS), and voice input and speech recognition applications.

Computer 101 and/or terminals 141 or 151 may also be devices including various other components, such as a battery, speaker, and antennas (not shown).

Terminal 151 and/or terminal 141 may be portable devices such as a laptop, cell phone, smartphone, smartwatch, or any other suitable device for storing, transmitting and/or transporting relevant information. Terminals 151 and/or terminal 141 may be other devices. These devices may be identical to system 100 or different. The differences may be related to hardware components and/or software components.

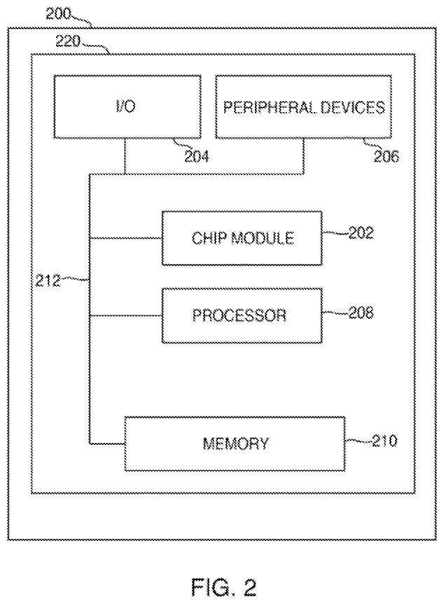

FIG. 2 shows illustrative apparatus 200. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device 208, which may test submitted information for validity, scrape relevant information, aggregate user financial data and/or provide an auth-determination score(s) and machine-readable memory 210.

Machine-readable memory 210 may be configured to store in machine-readable data structures: information pertaining to a user, information pertaining to an account holder and the accounts which he may hold, the current time, information pertaining to historical user account activity and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

Disclosed herein are systems, apparatuses and methods (“the system”) for dynamically and automatically ranking purchasers and sellers and matching orders in a reverse auction.

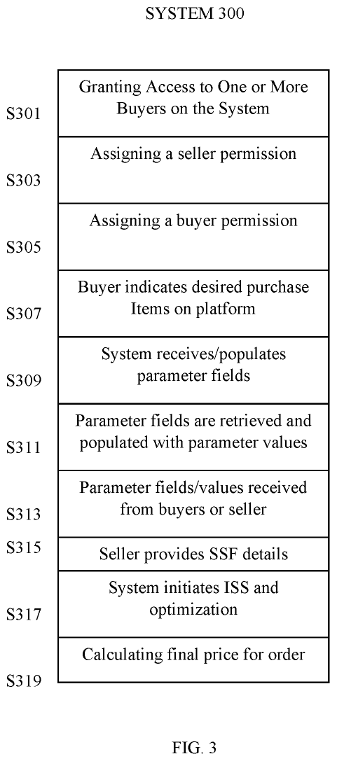

An exemplary process associated with the system is shown in FIG. 3. FIG. 3 thus illustrates system 300.

In an embodiment, the system 300 includes, and is in communication with, at least one buyer and at least one seller. The system 300 may therefore receive at least one offer to purchase an Item (as referred to herein, “Item” may include any item, product, or inventory purchased by a buyer or sold by a seller).

The system 300 may incorporate a portal or platform (also referred to as “platform 300”), and may be located on terminal 141, 151 in FIG. 1. However, in alternate embodiments, the portal or platform may be located on any suitable hardware component. The system 300 may be utilized in a plurality of steps, shown in FIG. 3. It should be noted that one or more of the steps need not necessarily be performed, and the order may be varied.

At a first step, in S301, one or more sellers and one or more buyers may be granted access to the system 300, in order to engage in tenders and offers for supplying various products. In an embodiment, from the buyer's perspective, there may be no specific pre-processing steps. However, in another embodiment, the buyer may undergo pre-processing steps. In an embodiment, the buyer may mainly utilize the “search” (for example, presented to the user on a computer display) and may fill a form (for example, a computer-implemented form presented to the user on a computer display) that specifies the required good and/or the characteristics of the required good, creating a specification. Moreover, from the seller's perspective, the seller may enter, for example, the stock details, pricing details, and/or delivery options prior to being considered by the system 300 in the reversed auction.

In S303, a seller may be assigned one or more seller permissions on the platform. The seller permissions may correspond to products that the seller may bid or sell on the system 300. Alternatively, the seller may be allowed to sell or bid on any suitable Item. The seller permissions may also correspond to parameters which may be viewed by the seller.

In S305, a buyer may be assigned one or more buyer permissions on the platform. The buyer permissions may correspond to products that the buyer may bid or purchase on the system 300. Alternatively, the buyer may be allowed to purchase or bid on any suitable product. The buyer permissions may also correspond to parameters which may be viewed by the buyer.

At S307, the buyer may indicate a desire to purchase various Items, and/or the seller may indicate a desire to sell various items, with such engagement occurring via a reverse auction. The reverse auction may provide for a method for sellers to bid on an order they wish to fulfill, and for buyers to tender offers for orders. The buyer may fill in a form provided by the system 300. In a similar fashion, the seller may enter the stocks, pricing, and delivery details. The entry of parameters fields and/or parameter values may be accomplished via the buyer and/or seller's interaction with an internet-connected computer.

At S309, the system 300 may receive, or may be populated with, parameter fields. These parameters or parameter fields may correspond to various attributes that may be associated with various Items.

Also at S309, various parameters associated with the parameter fields may be determined. It should be noted that parameters may be determined at S309, or may be set prior to any of S301-S307, and may be maintained as part of a portal backend. Alternatively, certain parameters may be specified or personalized to certain buyers or sellers.

At S311, parameter fields may be retrieved, and may be populated with one or more parameter values. As non-limiting example, parameter fields include, but are not limited to: price per unit, date of production, size, packaging, place of origin, national quality standard, and properties of the material that the item is made of (e.g. age of a cow in the case of steak, CPU speed in the case of computers), and geo-location of the item within the stock warehouse of the seller.

At S313, the parameter fields may be received from the seller. For example, the seller may input parameters values for fields such as inventory, price and logistic information. Accordingly, during the reverse auction, the algorithm may select all the input parameter values from the stock/pricing/delivery options already entered by the seller. Thus, in such an embodiment, the parameter values may be auto-generated based on buyer and/or seller input. In a further embodiment, the parameter fields and/or parameter values may be generated based on previous auctions. For example, the system 300 may retain information of specific Items, enabling the system 300 to automatically input this corresponding information if the seller and/or buyer again enters said specific Item.

The inventory may include quantity of Items in stock, or quantity of Items that may be in stock by a given date. The price may correspond to a per unit/Item price, or a bulk price. The logistic information may include offers of various shipping speeds, costs, and various shipping methods associated with each Item. The parameters may be standardized across the system 300. For example, the system may offer one or more standardized parameters for sellers to populate.

At S315, sellers may provide various information about Items in stock for the seller (for example, Stock Standard Form details).

At S317, the system may initiate the Inventory Standardization Service (“ISS”). The ISS may standardize information regarding Items in stock, utilizing the Stock Standard Form (“SSF”). Thus, the standardization may be performed automatically, utilizing the required Items, parameter fields, and specifications in the standard form.

In one embodiment, the SSF may include any information associated with an Item. That is, any parameters associated with an Item may be retrieved and populated into the SSF. For example, material, color, grade, quality, origin, or any other suitable parameter may be used to populate the SSF.

In another embodiment, Items may be classified according to: (1) Product-Category, as well as (2) Attributes (also referred to as “parameters”). For example, Product-Categories may be classified in description logic, such as Category1=Category2 and Category3, as illustrated by Beef-Jerky=Meat and Snack.

Thus, in accordance with an embodiment, each Item is reflected as a Product-Category, formed of one or more attributes. In another embodiment, every Item is formed of one or more attributes, such as attribute1=(Product1,v1), attribute2(Product2,v2). For example, a T-Bone Steak would be associated with the following attributes and scores (scores indicated by “v”):
a. Marbling=(T-Bone Steak-Product-001, MB8) (with MB corresponding to a marbling score)
b. Weight=(T-Bone Steak, 18 oz.)

In some embodiments, sellers new to system 300 may provide additional or new Item details. It should be noted that, in future instances, such new Item details may become standardized. Thus, in proceeding auctions, when the system 300 receives the same new Item details from any user, the system may recognize the Item and populate information accordingly.

An SSF database may be formed of an SSF database system, and may include a dynamically-generated data view, using, for example, the Extract Transform Load (“ETL”) process. In accordance with the invention, dynamically-generated data view is a searchable object. The dynamically-generated data view may be configured by one or more database queries, allowing the SSF to have access to the data exposed by the seller or buyer. In a further embodiment, the ETL may implement a general procedure of copying data from the seller or buyer to the SSF.

In an embodiment, the SSF database may provide data about the Seller and its Items in stock, in SSF. Thus, the database may include information about Item availability for each seller, as well as available volume (Mᵢⱼ), minimal price (Pᵢⱼ), desired price (Fᵢⱼ), scale rebate (Rᵢⱼ), scale threshold (for example, volume of items above which the scale rebate may be applied to the seller) (Tᵢⱼ), and any other suitable information. In the foregoing instance, i is the identifier of the product (e.g. Product1, Product2) and j is the identifier of the seller (e.g. Seller1, Seller2).

In some embodiments, the system 300 may assume that a minimal price, as well as a desired price, include any additional costs of delivery for an Item.

As discussed herein, minimal price may be the minimum price, below which the seller will not sell the Item. Thus, the minimal price may correspond to a reserve price. The desired price may correspond to the price desired by a seller, if possible, but indicating a willingness, if necessary, to accept a reduced price if certain additional requirements are met. Such additional requirements may include a minimum quantity. A scale rebate may be a rebate per item granted by a seller, if a buyer orders more than a threshold number of Items in a single or series of related orders.

The aforementioned parameters may be adjusted manually by the seller, or may be set for a predetermined period of time. In an embodiment, the parameters, such as minimal price, may be adjusted based on a percentage adjustment or dollar amount price tables.

Each Seller may provide a sufficient number of parameters to calculate a delivery cost, in order to deliver to a specified location by a specific deadline. This may be calculated using Dⱼ=delivery-cost (geolocation,deadline). Such a calculation therefore assumes that, depending on a distance from the Seller, different types of delivery, at varying cost, may be required to meet the deadline. In one embodiment, if geolocation or the deadline cannot be successfully completed in the required period, the function is invalid.

An example of calculating a minimal price for seller j, which is being asked to deliver xᵢⱼ items, from which yᵢⱼ are the ones with scale rebate, is:

Minimal price=Dⱼ+Σᵢ(Pᵢⱼxᵢⱼ−Rᵢⱼyᵢⱼ)

System 300 may incorporate an Item Specification (ItemSpec) system. The ItemSpec is the buyer side of system 300, corresponding to the seller SSF. This may allow buyers to categorize Items by parameters of properties/attributes associated with the Items, and which the buyers desire, to then be matched via the SSF database with the parameters input by the sellers. For example, material, weight, size, volume, color, quality, grade, unit size, origin, or any other suitable attribute may be used. For example, a Buyer may specify that a T-Bone-Steak should include ItemSpec “marbling 7+,” and “origin, Tasmania.”

It should be noted that ItemSpec, as utilized in System 300, functions similar to a filter. Thus, the more attributes specified in an ItemSpec, the more specific the SSF matched. Fewer attributes, on the other hand, result in greater SSF matches, with less specificity. An example of this logic is as follows:

Category1(?x)\hat{ }Category2(?x)\hat{ }Attribute2(?x)>=3\hat{ }Attribute3(?x)=1

E.g. Steak(?x)\hat{ }marbling(>7)—returns steak with marbling greater than 7.

In accordance with the invention, system 300 may also receive, from the Buyer, delivery location information, including delivery deadlines, as well as preferred freight type, if desired. The system 300 may then plug this information into the Seller geolocation information, as described herein.

An order on system 300 may be successfully realized if an ItemSpec matches corresponding SSFs. However, numerous realizations for a single order may occur, based on ItemSpecs matching multiple corresponding SSFs.

Returning to FIG. 3, at S317, the reverse auction may be initiated. The reverse auction may implement an automated commodity standardizer, and utilize an ISS and Automated Reverse Auction Solver (“ARAS”).

ARAS may compute optimal realization of an order, trying to minimize, and come as close to, the minimal price required by Seller. In some embodiments, a buyer order may result in more than one realization. In such a scenario, a Multiple Solution Selector (MSS) may be utilized. In one embodiment, the MSS may randomly select the realization. Alternatively, marketing processes may be utilized, for example, sellers may be asked to pay for being selected in such scenarios. In such an embodiment, sellers may elevate to ‘premium status’ and/or increase the priority of their Items as they appear to the buyer.

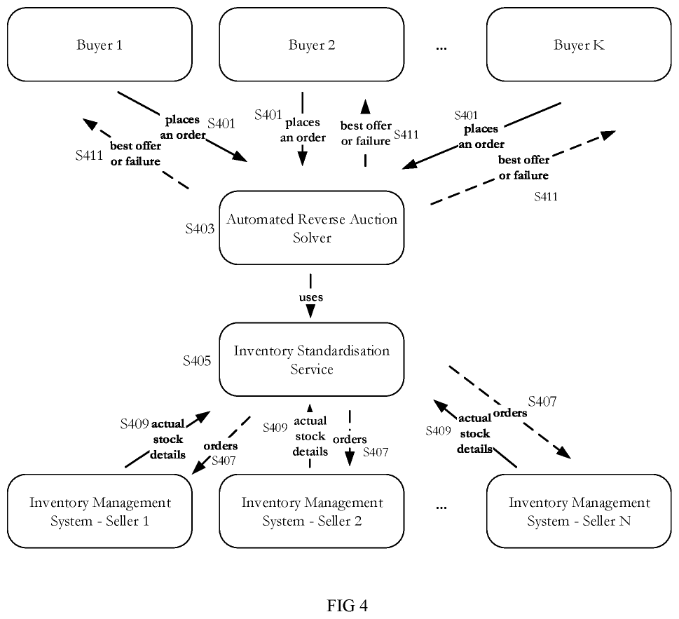

S317 may initiate process 400, shown in FIG. 4, comprising various steps.

At S401, a Buyer, such as Buyer 1 or Buyer 2, places an order.

At S403, an ARAS is utilized, and at S405, the ARAS utilizes the ISS.

At S407, the ISS transmits the order to an Inventory Management System (“IMS”) associated with sellers, such as Seller 1 or Seller 2.

At S409, Seller 1 and/or 2 provide actual stock details to the ISS/ARAS. In an embodiment, the IMS may provide such details to the ISS/ARAS.

At S411, the ARAS sends the best offer to the determined Buyer, otherwise a failure results.

Specific implementation of the system may place S403 and/or S405 in the Cloud, locally, and/or in the on-premise central datacenter. In an embodiment, the communication with the system is configured to be executed over the Internet using standard encryption (for example, HTTPS). The Buyer and Seller may be communicating with the system directly, for example, either via a mobile app or web-browser based app that may be using API methods disclosed by S403 and S405.

Returning now to FIG. 3, at S319, a final price for the order is calculated, using Final Price Computation (“FPC”). In one embodiment, FPC is calculated by replacing the minimal price with a desired price, if the desired price is lower than the minimal price of the closest competitor minus minimal auction step (e.g. 1 cent); otherwise the FPC is the closest competitor price minus a minimal auction step. In another embodiment, the FPC is calculated by determining, for each supplier, an alternative cost, using optimization without the supplier for a part of the order. The FPC may then equate to the delta between the minimal cost for the supplier and the alternative price. In an embodiment, an inversed auction is simulated by running the optimization in an iterative way.

As disclosed herein, the invention is uniquely suited to identify an optimal realization of an order matching between a buyer and seller. The realization may account for the entire market, as well as all costs, including delivery and availability. Thus, realization may be achieved by optimizing the order, and not using a set of linear rules.

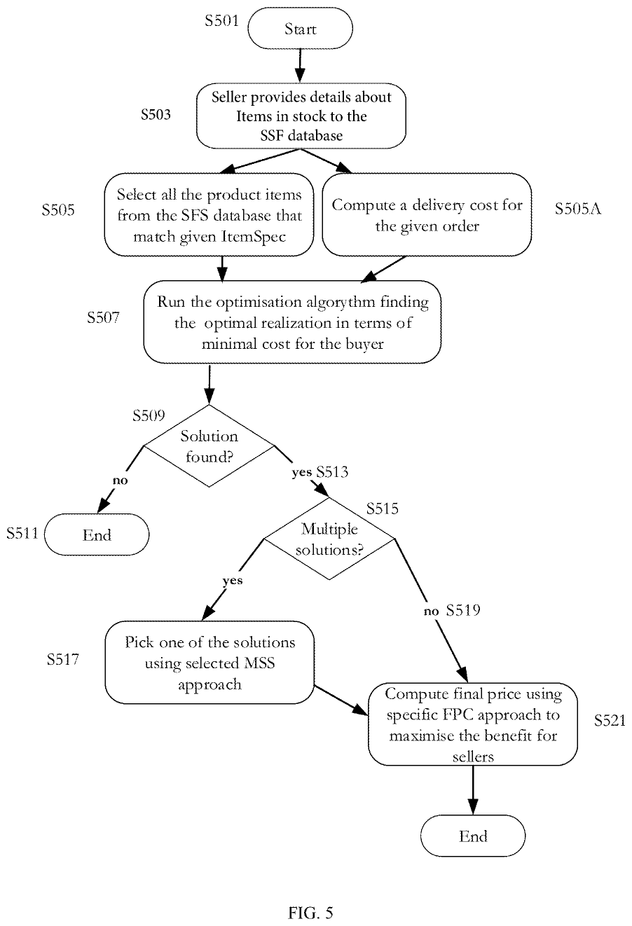

FIG. 5 illustrates a non-limiting exemplary implementation of the optimization process. At S501, the system starts.

At S503, one or more sellers on platform 300 provide details about Items in stock to the SSF database.

At S505, buyers on platform 300 provide ItemSpec, detailing one or more attributes/parameters associated with various Items they wish to purchase on the platform, to the SSF database. At the same time (or any suitable time), at S505a, a delivery cost for the given order may be calculated.

At S507, an optimization algorithm is run, determining the optimal realization of minimal cost for the buyer.

At S509, system 300 determines whether a solution has been found.

At S511, in one alternative, the system determines that no solution has been found, and ends the process.

At S513, in another alternative, the system determines that a solution has been found.

At S515, the system determines if multiple solutions have been found, and proceeds to either S517 or S519.

At S517, the system determines that multiple solutions have been found, and picks one of the solutions using a selected multiple solution selection approach. The system then proceeds to S521.

At S519, the system determines that only one solution has been found. The system then proceeds to S521.

At S521, the system computes a final price using a specific Final Price Calculation approach, in order to maximize the benefit to potential sellers.

In one embodiment, optimization of system 300 may be accomplished utilizing a quote-my-order system. In accordance with this embodiment, the platform may incorporate N Items in stock, and M Sellers.

Optimization of order allocation may be accomplished using a mixed integer programming optimization problem, looking for a matrix xᵢⱼ, with xᵢⱼ being the number of Items (i) to be shipped by a specified Seller (j). This is embodied by:

xᵢⱼ=amount of items i to be shipped by seller j
i∈{1 . . . N}
j∈{1 . . . M}

In some instances xᵢⱼ may be a natural number, xᵢⱼ∈{Z} (for example, pure Integer-Programming). However, when the value is continuous and unending (such as sugar, fruits, etc.), mixed integer programming is utilized, then Item stock is determined by, xᵢⱼ≤Mᵢⱼ, and the number of Items in a Seller's stock is determined by specifying the i-th number of stock items ordered by the customer. Thus, in an embodiment, for every eligible xᵢⱼ and order [symbol] ᵢ (for example, vector [symbol] ᵢ may be a vector that specifies the i-th number of stock items ordered by the customer), the sum of Items offered by all suppliers must, as a whole, equal to the number of the order, determined by:

$${\sum }_{j} {x}_{i j} = {Q}_{i}$$

Therefore, for the price of a single item offered by the seller, and modeled by the matrix Pᵢⱼ, optimization is determined by:

$$Minimize {\sum }_{i} {\sum }_{j} {P}_{i j} {x}_{i j}$$

While optimization may take into account price and stock, it may not account for delivery costs. Thus, the system may further incorporate a fixed cost of delivery. More specifically, fixed delivery costs, such as gas, truck rental or purchase, personnel, may not be reflected, and may not scale with the number of items. The delivery cost for a particular seller j may be represented as Dⱼ. In an embodiment, delivery costs may only appear to a seller if there are Items to be delivered by the seller. In order to account for the fixed cost of delivery, in an instance where the Seller J is delivering only some of the Items, the following is used:

$${\sum }_{i} x i j - {f}_{j} {\sum }_{i} {Q}_{i} \leq 0 \\ {f}_{j} ∈ \{ 0 , 1 \}$$

In an embodiment, if Σxᵢⱼ>0 (for example, indicating that the seller j is delivering some quantity of items), then fᵢ cannot be 0 because such a value will cause a contradiction where 0<Σxᵢⱼ≤0. Thus, in such an embodiment, if the seller j is delivering some quantity of items, then fⱼ=1. Further, in such an embodiment, Σxᵢⱼ−Σ [symbol] ᵢ≤0, which may always be true as Σ [symbol] ᵢ is the total number of items in order [symbol] ᵢ.

Moreover, on the other hand, if Σxᵢⱼ=0 then fⱼ may be 0. In this embodiment, fⱼ may also be 1, but such a value would indicate that the seller is driving without the items, which may be eliminated by the optimization algorithm. In sum, in an embodiment, if Seller j is delivering some items, fᵢ cannot be =0, so fᵢ=1.

The system may also account for incorporating effect of scale. Seller economy of scale is determined when shipping above a certain threshold quantity Tᵢⱼ. Thus, while Pᵢⱼ is the regular price, whenever Item quantity exceeds Tᵢⱼ, a specific rebate R may be provided, reducing the overall cost. In an embodiment, yᵢⱼ indicates the number of Items above the threshold, such that:

iᵢⱼ=Tᵢⱼμᵢⱼ+Mᵢⱼδᵢⱼ

1=eᵢⱼ+μᵢⱼ+δᵢⱼ

μᵢⱼ,δᵢⱼ≥0

eᵢⱼ∈{0,1}

yᵢⱼ≤xᵢⱼ

Thus, in an embodiment:

1. If eᵢⱼ=1, then both μᵢⱼ=0 and δᵢⱼ=0, so yᵢⱼ=0.

2. If eᵢⱼ=0, then μᵢⱼ=1−δᵢⱼ, so Tᵢⱼ≤yᵢⱼ≤Mᵢⱼ,

3. On the other hand, yᵢⱼ≤xᵢⱼ,

4. So Tᵢⱼ=0∨Tᵢⱼ≤yᵢⱼ≤xᵢⱼ

Optimization may therefore be determined using the following calculation:

$$Minimize {\sum }_{i} {\sum }_{j} ( {P}_{i j} {x}_{i j} - {R}_{i j} {y}_{i j} ) + {\sum }_{j} {D}_{j} {f}_{j}$$

In a further embodiment, the model can be extended to more distribution stages (for example, producer, retailer, or customer). Further, the model may be configured to prevent order splitting.

In additional embodiments, a seller may, instead of utilizing ARAS/ISS, directly bid on an order. Further, the system 300 may be utilized in a distributed ledger format, such as blockchain, to allow for smart contracting.

It should be noted that the systems and methods described herein may be utilized for logistics and delivery, as well as complex sales, services, loans, financial and insurance products, commodities, and energy and gas trading.

The invention of the present disclosure may be a computer implemented system for dynamically ranking buyers and sellers in an auction comprising one or more processors, one or more computer-readable memories, one or more displays, and one or more computer-readable storage devices, and program instructions stored on at least one of the one or more computer-readable storage devices for execution by at least one of the one or more processors via at least one of the one or more computer-readable memories. In an embodiment, the stored program instructions comprise granting access to one or more buyers on the computer implemented system, assigning at least one seller permission, assigning at least one buyer permission, providing, to the seller and the buyer, a platform, receiving, via the platform, one or more desired items, receiving a plurality of parameter fields, populating each of the plurality of parameter fields with one or more parameter values, and receiving the plurality of parameter fields and one or more parameter values from at least one of the buyer and seller. The stored program instructions may further include standardizing the one or more parameter values and the plurality of parameter fields into one or more Stock Standard Form (SSF) details, initiating an Inventory Standardization Service (ISS), initiating an optimization, and calculating a final price for the one or more desired items.

In an embodiment, the optimization comprises receiving details about items in stock to the SSF database, detailing one or more parameters associated with the one or more desired items to the SSF database, and calculating a delivery cost for a given order, wherein the given order includes the one or more desired items. The optimization may further include running an optimization algorithm, determining, via the optimization algorithm, an optimal realization of minimal cost for the buyer, determining whether one or more solutions have been found, where if one solution has not been found, end the optimization, and where if one or more solutions has been found, continue the optimization. The optimization may also comprise selecting, if more than one solutions have been found, one of the one or more solutions using a multiple solution selection approach and computing the final price using a Final Price Calculation (FPC) approach, where the FPC approach is configured to maximize benefit to potential sellers.

In an embodiment, the optimization is accomplished utilizing an optimization of order allocation, wherein optimization of order allocation utilizes a mixed integer programming optimization problem, solving for a matrix xᵢᵢ, with xᵢᵢ being the number of items (i) to be shipped by a Seller (j) according to the following:

xᵢⱼ=amount of items i to be shipped by seller j; i∈{1 . . . N}; and j∈{1 . . . M},

where N is items in stock, and M is the Sellers. In another embodiment, the optimization is determined using a following formula: Minimize ΣᵢΣⱼ(Pᵢⱼxᵢⱼ−Rᵢⱼyᵢⱼ)+ΣⱼDⱼfⱼ, wherein Pᵢⱼ is a minimal price, Rᵢⱼ is a scale rebate, Dⱼ is a delivery cost, xᵢⱼ is an amount of items i to be shipped by seller j, yᵢⱼ are the items with the scale rebate, and fⱼ is an element of a set {0, 1}.

Initiating the ISS may further comprise receiving an order from the buyer, utilizing an Automated Reverse Auction Solver (ARAS), utilizing, via the ARAS, the ISS, transmitting the order, from the ISS to an Inventory Management System (IMS) associated with the seller, receiving, from the seller, one or more stock details to the ISS and ARAS, and sending a best offer to the buyer, via the ARAS.

In an embodiment, the plurality of parameters comprises quality, delivery period, stock keeping unit (“SKU”), quantity, and seller reputation. The one or more desired items received, via the platform, may be based on the at least one seller permission, or the at least one buyer permission. The plurality of parameter fields may be populated, or not populated, with the one or more parameter values based on the at least one seller permission, or the at least one buyer permission.

While this invention has been described in conjunction with the embodiments outlined above, many alternatives, modifications and variations will be apparent to those skilled in the art upon reading the foregoing disclosure. Accordingly, the embodiments of the invention, as set forth above, are intended to be illustrative, not limiting. Various changes may be made without departing from the spirit and scope of the invention.

What is claimed is:

1. A computer implemented system for dynamically ranking buyers and sellers in an auction comprising one or more processors, one or more computer-readable memories, one or more displays, and one or more computer-readable storage devices, and program instructions stored on at least one of the one or more computer-readable storage devices for execution by at least one of the one or more processors via at least one of the one or more computer-readable memories, the stored program instructions comprising:
granting access to one or more buyers on the computer implemented system;
assigning at least one seller permission;
assigning at least one buyer permission;
providing, to the seller and the buyer, a platform;
receiving, via the platform, one or more desired items;
receiving a plurality of parameter fields;
populating each of the plurality of parameter fields with one or more parameter values;
receiving the plurality of parameter fields and one or more parameter values from at least one of the buyer and seller;
standardizing the one or more parameter values and the plurality of parameter fields into one or more Stock Standard Form (SSF) details;
initiating an Inventory Standardization Service (ISS);
initiating an optimization; and
calculating a final price for the one or more desired items.

2. The computer implemented system of claim 1, wherein the optimization further comprises:
receiving details about items in stock to the SSF database;
detailing one or more parameters associated with the one or more desired items to the SSF database;
calculating a delivery cost for a given order,
wherein the given order includes the one or more desired items;
running an optimization algorithm;
determining, via the optimization algorithm, an optimal realization of minimal cost for the buyer;
determining whether one or more solutions have been found,
wherein if one solution has not been found, end the optimization, and
wherein if one or more solutions has been found, continue the optimization;
selecting, if more than one solutions have been found, one of the one or more solutions using a multiple solution selection approach; and
computing the final price using a Final Price Calculation (FPC) approach,
wherein the FPC approach is configured to maximize benefit to potential sellers.

3. The computer implemented system of claim 1, wherein the optimization is accomplished utilizing an optimization of order allocation, wherein optimization of order allocation utilizes a mixed integer programming optimization problem, solving for a matrix xᵢᵢ, with xᵢⱼ being the number of items (i) to be shipped by a Seller (j) according to the following:
xᵢⱼ=amount of items i to be shipped by seller j
i∈{1 . . . N}
j∈{1 . . . M},
wherein N is items in stock, and M is the Sellers.

4. The computer implemented system of claim 1, wherein the optimization is determined using a following formula:
Minimize ΣᵢΣⱼ(Pᵢⱼxᵢⱼ−Rᵢⱼyᵢⱼ)+ΣⱼDⱼfⱼ,
wherein Pᵢⱼ is a minimal price, Rᵢⱼ is a scale rebate, Dⱼ is a delivery cost, xᵢⱼ is an amount of items i to be shipped by seller j, yᵢⱼ are the items with the scale rebate, and fⱼ is an element of a set {0, 1}.

5. The computer implemented system of claim 1, wherein initiating the ISS further comprises:
receiving an order from the buyer;
utilizing an Automated Reverse Auction Solver (ARAS);
utilizing, via the ARAS, the ISS;
transmitting the order, from the ISS to an Inventory Management System (IMS) associated with the seller;
receiving, from the seller, one or more stock details to the ISS and ARAS; and
sending a best offer to the buyer, via the ARAS.

6. The computer implemented system of claim 1, wherein the plurality of parameters comprises quality, delivery period, stock keeping unit (“SKU”), quantity, and seller reputation.

7. The computer implemented system of claim 1, wherein the one or more desired items received, via the platform, is based on the at least one seller permission.

8. The computer implemented system of claim 1, wherein the plurality of parameter fields are populated with the one or more parameter values based on the at least one seller permission.
